(19) United States
(12) Patent Application Publication
(10) Pub. No.: US 2013/0226948 A1
(43) Pub. Date: Aug. 29, 2013

(54) System and Method for Providing Region-Based Epidemic Disease Information

(71) Applicants: Byung Keun Ahn, Seoul (KR); Jong Ho Jung, Seoul (KR)

(72) Inventors: Byung Keun Ahn, Seoul (KR); Jong Ho Jung, Seoul (KR)

(73) Assignee: UBCARE CO., LTD., Seoul (KR)

(21) Appl. No.: 13/817,771

(22) PCT Filed: Sep. 29, 2010
(86) PCT No.: PCT/KR2010/006639

§ 371 Date: May 13, 2013

(30) Foreign Application Priority Data
Aug. 17, 2010 (KR) 10-2010-0079236

(51) Int. Cl. G06F 17/30

(52) U.S. Cl. CPC G06F 17/30386
USPC 707/758

(57) ABSTRACT

Disclosed are a system and a method for providing region-based epidemic disease information. The system for providing region-based epidemic disease information comprises: a sensing unit which senses the movement of a mobile communication terminal from a first location to a second location; and a processor linked to the sensing unit which extracts first zone disease information corresponding to the first location from a database, and compares with second zone disease information corresponding to the second location and ensures that the mobile communication terminal is provided with the second zone disease information if, as a result of the comparison, the first zone disease information differs from the second zone disease information.

### CROSS-REFERENCE TO RELATED APPLICATIONS

This application is a national phase entry claiming priority under 35 U.S.C. §119(a)-(d) to International Patent Cooperation Treaty Application No. PCT/KR2010/006639, the entire disclosure of which is incorporated herein by reference.

### BACKGROUND OF THE INVENTION

1. Field of the Invention

The present invention relates to a system and method for providing epidemic disease information that may provide a mobile communication terminal with zone disease information corresponding to a location to which the mobile communication terminal is moved, in response to the mobile communication terminal being moved, thereby enabling a user of the mobile communication terminal to handle a disease easily.

2. Description of Related Art

A patient may submit prescription information prepared by a doctor for treatment to a hospital/pharmacy to purchase medicines. The prescription information may be stored and managed in a database of a prescription information server of each hospital/pharmacy. When personal information is input, for example, a name, and/or a Social Security number, the prescription information server may extract prescription information corresponding to the input personal information from the database in which prescription information is recorded, and provide the extracted prescription information.

A disease information monitoring system configured to access the prescription information server to collect prescription information may generate zone disease information using the collected prescription information, and provide the zone disease information to a mobile communication terminal in response to a request for disease information from the mobile communication terminal, thereby enabling preventive measures to be organized.

However, since the disease information monitoring system may provide zone disease information in response to the request from the mobile communication terminal, a user of the mobile communication terminal may experience an inconvenience in inputting a request command, directly, with respect to the zone disease information.

Accordingly, there is a need for a technology for alleviating such an inconvenience of the user by sensing a movement of a mobile communication terminal, identifying a location to which the mobile communication terminal is moved, and providing the mobile communication terminal with zone disease information corresponding to the location, irrespective of a request from the mobile communication terminal.

### BRIEF SUMMARY OF THE INVENTION

### Technical Goals

An aspect of the present invention provides a system and method that may provide a mobile communication terminal with zone disease information corresponding to a location to which the mobile communication terminal is moved, in response to the mobile communication terminal being moved, thereby enabling a user of the mobile communication terminal to handle a disease easily.

Another aspect of the present invention also provides a system and method that may process zone disease information corresponding to a location to which a mobile communication terminal is moved, in a form of at least one of a bar graph, a line graph, and a diagram, and provide the mobile communication terminal with the processed zone disease information, thereby enabling a user of the mobile communication terminal to be aware of the zone disease information easily.

### Technical Solutions

According to an aspect of the present invention, there is provided a system for providing region-based epidemic disease information, the system including a sensing unit to sense a movement of a mobile communication terminal from a first location to a second location, and a processor to extract first zone disease information corresponding to the first location and second zone disease information corresponding to the second location from a database, in line with the sensing, to compare the extracted first zone disease information to the extracted second zone disease information, and to provide the mobile communication terminal with the second zone disease information when the first zone disease information differs from the second zone disease information as a result of the comparing.

The processor may process the second zone disease information in a form of at least one of a bar graph, a line graph, and a diagram, and provide the mobile communication terminal with the processed second zone disease information.

According to another aspect of the present invention, there is also provided a method of providing region-based epidemic disease information, the method including sensing a movement of a mobile communication terminal from a first location to a second location, extracting first zone disease information corresponding to the first location and second zone disease information corresponding to the second location from a database, in line with the sensing, and comparing the extracted first zone disease information to the extracted second zone disease information, and enabling the mobile communication terminal to be provided with the second zone disease information when the first zone disease information differs from the second zone disease information as a result of the comparing.

The method may further include processing the second zone disease information in a form of at least one of a bar graph, a line graph, and a diagram, and providing the mobile communication terminal with the processed second zone disease information.

### ADVANTAGEOUS EFFECTS

According to embodiments of the present invention, in response to a mobile communication terminal being moved, zone disease information corresponding to a location to which the mobile communication terminal is moved may be provided to the mobile communication terminal, whereby a user of the mobile communication terminal may handle a disease easily.

According to embodiments of the present invention, zone disease information corresponding to a location to which a mobile communication terminal is moved may be processed in a form of at least one of a bar graph, a line graph, and a diagram, and provided to the mobile communication terminal, whereby a user of the mobile communication terminal may be aware of the zone disease information easily.

### BRIEF DESCRIPTION OF THE SEVERAL VIEWS OF THE DRAWINGS

FIG. 1 is a diagram illustrating a relationship among a mobile communication terminal, a prescription information server, and a system for providing region-based epidemic disease information according to an embodiment of the present invention.

FIG. 2 is a block diagram illustrating a configuration of a system for providing region-based epidemic disease information according to an embodiment of the present invention.

FIG. 3 is a diagram illustrating an example of zone disease information provided by a system for providing region-based epidemic disease information according to an embodiment of the present invention.

FIG. 4 is a diagram illustrating another example of zone disease information provided by a system for providing region-based epidemic disease information according to an embodiment of the present invention.

FIG. 5 is a flowchart illustrating a method of providing region-based epidemic disease information according to an embodiment of the present invention.

### DETAILED DESCRIPTION OF THE INVENTION

Hereinafter, a system and method for providing region-based epidemic disease information according to an embodiment of the present invention will be described in detail with reference to the accompanying drawings. Herein, a mobile communication terminal may correspond to, for example, a cellular phone, a personal digital assistant (PDA), or the like, and may be provided with zone disease information from an epidemic disease information providing system when the mobile communication terminal is moved. In addition, a prescription information server may correspond to, for example, a personal computer (PC), a local server, or the like, and may be disposed in hospitals or pharmacies of each region to store/manage prescription information, to transfer the prescription information to the epidemic disease information providing system, and to provide basic data to be used to generate zone disease information.

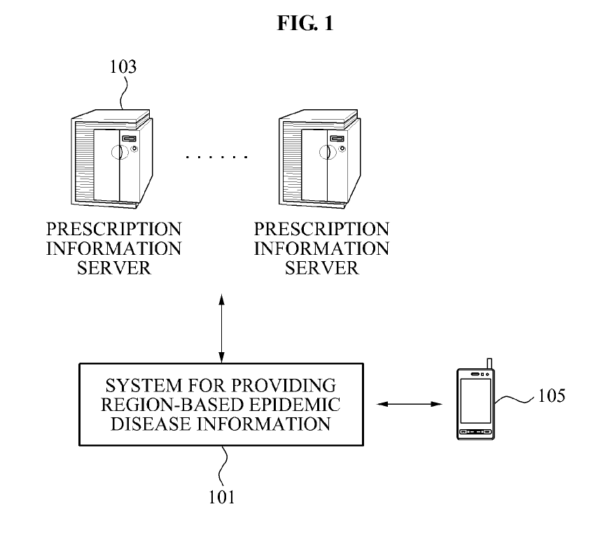

FIG. 1 is a diagram illustrating a relationship among a mobile communication terminal, a prescription information server, and a system for providing region-based epidemic disease information according to an embodiment of the present invention.

Referring to FIG. 1, a system 101 for providing region-based epidemic disease information may be disposed in each region to receive prescription information periodically or in real time from a prescription information server 103 being connected to the system 101 over a communication network. In this instance, when an information input event is received from the prescription information server 103, the system 101 may receive the prescription information along with the information input event.

Here, the prescription information may include at least one of a disease type, for example, a disease code, a prescription drug, personal information, for example, a name, a gender, and an age, and a date.

The system 101 may analyze the prescription information received from the prescription information server 103 in view of a region code of the prescription information server 103, and store, in a database, zone disease information generated as a result of the analyzing.

Here, the zone disease information may include a number of prescriptions with respect to a disease type, a gender, an age, or a period, a result of analyzing a current state of disease, for example, an extent of disease transmission, a remedy for a disease, and the like, in relation to a region.

In addition, the system 101 may sense a movement of a mobile communication terminal 105 to which a connection is being made, and transmit, to the mobile communication terminal 105, zone disease information corresponding to a region in which the mobile communication terminal 105 is positioned, in line with the sensing. In this instance, the system 101 may process the zone disease information in a form of at least one of a bar graph, a line graph, and a diagram, and provide the mobile communication terminal 105 with the processed zone disease information. In addition, the system 101 may provide the mobile communication terminal 105 with map data along with the zone disease information, and control the mobile communication terminal 105 to display the location to which the mobile communication terminal 105 is moved and the zone disease information to be mapped to the map data, thereby enabling a location of a user and zone disease information corresponding to the location may be verified easily.

The prescription information server 103 may be disposed in each region to transmit an information input event and prescription information to the system 101.

Although the prescription information server 103 may transmit prescription information to the system 101 in real time when a prescription is received, a scheme of transmitting the prescription information is not to be limited thereto. The prescription information server 103 may transmit prescription information to the system 101 on an hourly/daily/weekly basis.

When a location of the mobile communication terminal 105 is changed as the mobile communication terminal 105 is moved, the mobile communication terminal 105 may receive zone disease information corresponding to the location of the mobile communication terminal 105 from the system 101, and display the received zone disease information to be mapped to the map data.

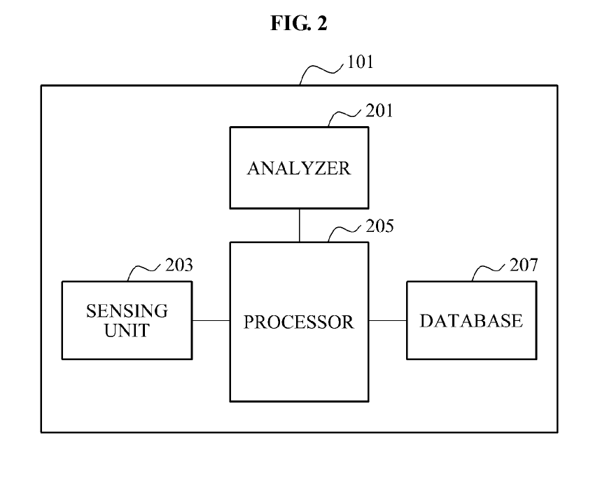

FIG. 2 is a block diagram illustrating a configuration of a system for providing region-based epidemic disease information according to an embodiment of the present invention.

Referring to FIG. 2, the system 101 may include an analyzer 201, a sensing unit 203, a processor 205, and a database 207.

The analyzer 201 may receive prescription information from an external prescription information server, analyze the received prescription information in view of a region code corresponding to a location of the prescription information server, and store, in the database 207, zone disease information generated as a result of the analyzing. In this instance, the analyzer 201 may analyze the received prescription information, based on at least one of a disease type, a gender, an age, and a period. In addition, the zone disease information may include, in relation to a region, a number of prescriptions with respect to a disease type, a gender, an age, or a period, a result of analyzing a current state of a disease, for example, an extent of disease transmission, a remedy for a disease, and the like.

The sensing unit 203 may sense a movement of the mobile communication terminal 105. In particular, the sensing unit 203 may sense a movement of the mobile communication terminal 105 being moved from a first location to a second location.

In this instance, the sensing unit 203 may sense the movement of the mobile communication terminal 101 when the first location and the second location are included in different respective regions, based on regions classified when zone disease information is stored in the database 207. For example, when zone disease information with respect to “Gangnam District”, “Gangbuk District”, and “Gangdong District” is stored in the database 207, the sensing unit 203 may sense a movement of the mobile communication terminal 105 from “Gangbuk District” to “Gangnam District”. However, the sensing unit 203 may not sense a movement of the mobile communication terminal 105 from “Sinsa-dong” of “Gangnam District” to “Nonhyeon-dong” of “Gangnam District”. The movement from “Sinsa-dong” to “Nonhyeon-dong” may not be sensed because movement sensing may be meaningless since “Sinsa-dong” is close to “Nonhyeon-dong” and thus, the respective disease environments are similar. Accordingly, disease information corresponding to “Sinsa-dong” may be identical to zone disease information corresponding to “Nonhyeon-dong”.

Although the sensing unit 203 may sense a movement of the mobile communication terminal 105 by receiving a location of the mobile communication terminal 105 from a communication server (not shown) configured to control communication of the mobile communication terminal 105, a scheme of sensing the movement is not to be limited thereto.

The processor 205 may extract first zone disease information corresponding to the first location and second zone disease information corresponding to the second location from the database 207, in line with the sensing.

In this instance, the processor 205 may verify a region code corresponding to the first location and a region code corresponding to the second location from a code matching table stored in the database 207, and extract the first zone disease information and the second zone disease information corresponding to the verified region codes from the database 207. For example, when a movement from “Gangbuk District” to “Gangnam District” is sensed, the processor 205 may verify a region code “0001” corresponding to “Gangbuk District” and a region code “0003” corresponding to “Gangnam District” from the code matching table, in line with the sensing, and extract first zone disease information corresponding to the verified region code “0001” and second zone disease information corresponding to the verified region code “0003” from the database 207.

The processor 205 may compare the extracted first zone disease information to the extracted second zone disease information, and provide the second zone disease information to the mobile communication terminal 105 when the first zone disease information differs from the second zone disease information as a result of the comparing, thereby enabling a user of the mobile communication terminal 105 to handle a disease easily. In this instance, the processor 205 may provide the mobile communication terminal 105 with map data along with the second zone disease information, and control the mobile communication terminal 105 to display the second location and the second zone disease information to be mapped to the map data, thereby enabling the user of the mobile communication terminal 105 to verify a location of the user and zone disease information corresponding to the location easily.

The processor 205 may process the second zone disease information in a form of at least one of a bar graph, a line graph, and a diagram, and provide the mobile communication terminal 105 with the processed second zone disease information, thereby enabling the user of the mobile communication terminal 105 to be aware of zone disease information easily. For example, the processor 205 may process the second zone disease information in a form of a bar graph showing a number of prescriptions with respect to a disease type, a gender, an age, or a period, or in a form of a line graph showing a number of prescriptions with respect to an age or a period, and transmit the processed second zone disease information to the mobile communication terminal 105. In addition, the processor 205 may process the second zone disease information in a form of a diagram showing a number or proportion of prescriptions with respect to a disease type, a gender, an age, or a period, and transmit the processed second zone disease information to the mobile communication terminal 105.

When a number of cases of a specific disease, for example, a number of prescriptions with respect to the specific disease, is greater than or equal to a predetermined number in the second zone disease information, the processor 205 may provide the mobile communication terminal 105 with a warning message along with the second zone disease information, thereby inducing a rapid awareness of a risk of the specific disease in the user of the mobile communication terminal 105 such that preventive measures may be taken against the specific disease.

When the processor 205 transmits the second zone disease information, the processor 205 may transmit a portion of the second zone information differing from the first zone information to the mobile communication terminal 105, rather than transmitting the entire second zone disease information to the mobile communication terminal 105, thereby increasing a transmission efficiency. For example, when a remedy for hand, foot, and mouth disease (HFMD) included in the second zone disease information is included in the first zone disease information, the processor 205 may transmit a portion of the second zone disease information excluding the remedy for HFMD to the mobile communication terminal 105.

The database 207 may store the zone disease information generated by the analyzer 201, as a result of analyzing the prescription information. The database 207 may update the zone disease information periodically or in real time when prescription information is received from the prescription information server. In addition, the database 207 may additionally store the code matching table in which a region code for each location is recorded.

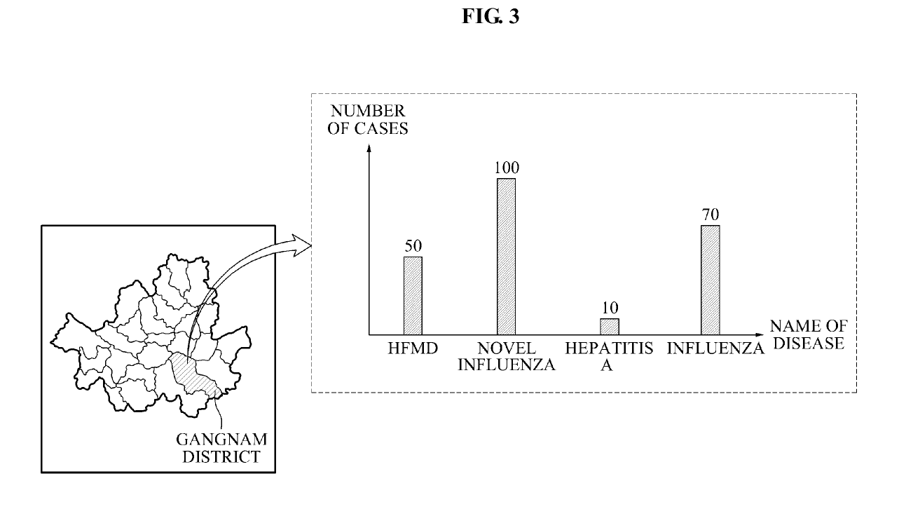

FIG. 3 is a diagram illustrating an example of zone disease information provided by a system for providing region-based epidemic disease information according to an embodiment of the present invention.

Referring to FIG. 3, a system for providing region-based epidemic disease information, hereinafter the system, may extract first zone disease information corresponding to a first location and second zone disease information corresponding to a second location, and compare the first zone disease information to the second zone disease information when a mobile communication terminal is moved from the first location to the second location. When the first zone disease information differs from the second zone disease information as a result of the comparing, the system may provide the mobile communication terminal with the second zone disease information.

For example, when a movement from “Gangbuk District” to “Gangnam District” is sensed, the system may extract first zone disease information corresponding to “Gangbuk District” and second zone disease information corresponding to “Gangnam District” from a database, compare the first zone disease information to the second zone disease information, and provide the mobile communication terminal with the second zone disease information when the first zone disease information differs from the second zone disease information as a result of the comparing.

In this instance, the system may process the second zone disease information in a form of a bar graph showing a number of prescriptions with respect to a disease type, a gender, an age, or a period, and transmit the processed second zone disease information to the mobile communication terminal. For example, the system may process the second zone disease information in a form of a bar graph showing a number of prescriptions with respect to “HFMD”, “novel influenza”, “hepatitis A”, and “influenza”, and transmit the processed second zone disease information to the mobile communication terminal.

Here, a reference number for warning a user about “novel influenza” may be set to “70” cases. In this instance, since a number of prescriptions with respect to “novel influenza” corresponds to “100” cases, the system may transmit a warning message in relation to a “Risk of novel influenza transmission” along with the second zone disease information processed in a form of the bar graph to the mobile communication terminal.

In addition, the system may provide the mobile communication terminal with map data along with the second zone disease information corresponding to “Gangnam District”, and control the mobile communication terminal to display the second zone disease information to be mapped to the map data, pertaining to a location to which the mobile communication terminal is moved, in particular, “Gangnam District”.

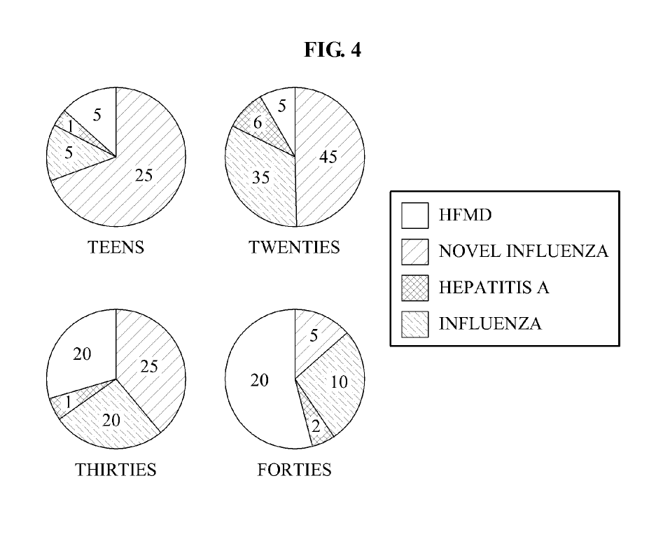

FIG. 4 is a diagram illustrating another example of zone disease information provided by a system for providing region-based epidemic disease information according to an embodiment of the present invention.

The system may process second zone disease information in a form of a diagram showing a number or proportion of prescriptions with respect to a disease type, a gender, an age, or a period, and transmit the processed second zone disease information to the mobile communication terminal. For example, the system may process second zone disease information corresponding to “Gangnam District” in a form of a diagram showing a number of prescriptions with respect to each disease type, for example, a name of disease, according to ages, for example, teens, twenties, thirties, and forties, and transmit the processed second zone disease information to the mobile communication terminal. In particular, a user may learn that an incidence of a disease is highest in adults in their twenties, and an incidence of “novel influenza” is higher than an incidence of other diseases in teenagers and adults in their twenties. In this instance, users in their twenties may learn precaution should be taken for all diseases, in particular, to avoid becoming infected with “novel influenza”.

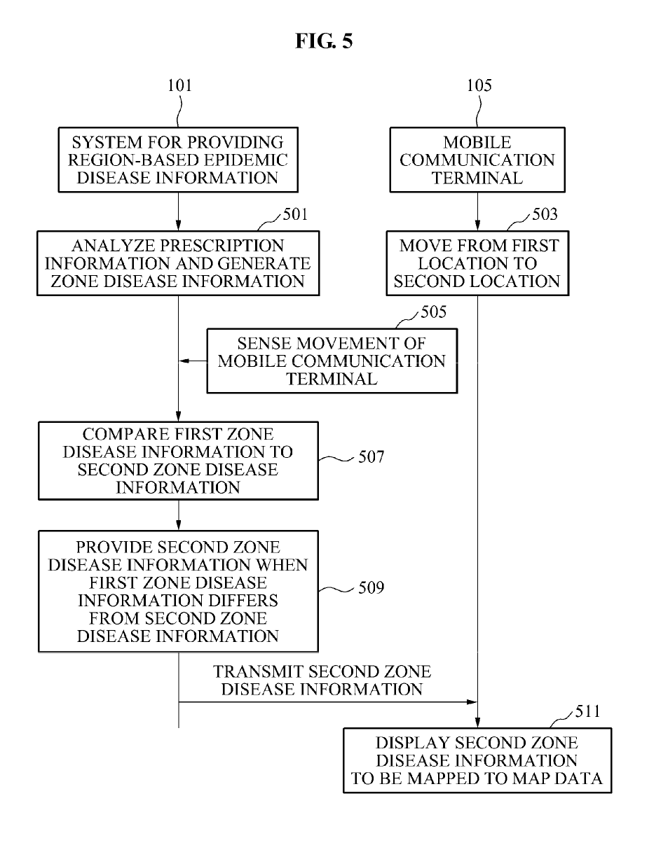

FIG. 5 is a flowchart illustrating a method of providing region-based epidemic disease information according to an embodiment of the present invention.

Referring to FIG. 5, in operation 501, the system 101 may receive prescription information from a separate prescription information server, and generate zone disease information by analyzing the received prescription information in view of a region code corresponding to a location of the prescription information server. In this instance, the system 101 may analyze the received prescription information based on at least one of a disease type, a gender, an age, and a period.

Here, the system 101 may store and manage the received prescription information, and the zone disease information generated using the prescription information, in a database.

When the mobile communication terminal 105 is moved from a first location to a second location in operation 503, the system 101 may sense the movement of the mobile communication terminal 105, in operation 505. Here, the system 101 may sense the movement of the mobile communication terminal 105 when the first location and the second location are included in different respective regions, in relation to zone disease information.

In operation 507, the system 101 may extract first zone disease information corresponding to the first location and second zone disease information corresponding to the second location from the database, and compare the first zone disease information to the second zone disease information. In this instance, the system 101 may verify a region code corresponding to the first location and a region code corresponding to the second location from a code matching table stored in the database, and extract the first zone disease information and the second zone disease information corresponding to the verified region codes, from the database.

For example, the system 101 may compare the first zone disease information to the second zone disease information, based on disease types occurring at the first location and the second location, a number of cases of each disease type, and the like.

In operation 509, the system 101 may provide the second zone disease information to the mobile communication terminal 105 when the first zone disease information differs from the second zone disease information as a result of the comparing, thereby enabling a user of the mobile communication terminal 105 to handle a disease easily. In this instance, the system 101 may process the second zone disease information in a form of at least one of a bar graph, a line graph, and a diagram, and provide the processed second zone disease information to the mobile communication terminal 105, thereby enabling the user of the mobile communication terminal 105 to be aware of the zone disease information easily.

In addition, when a number of cases of a specific disease is greater than or equal to a predetermined number in the second zone disease information, the system 101 may provide the mobile communication terminal 105 with a warning message along with the second zone disease information, thereby inducing a rapid awareness of a risk of the specific disease in the user of the mobile communication terminal 105 such that preventive measures may be taken against the specific disease.

The system 101 may provide the mobile communication terminal 105 with map data along with the second zone disease information, thereby controlling the mobile communication terminal 105 to display the second location and the second zone disease information to be mapped to the map data.

In operation 511, the mobile communication terminal 105 may display the second location to which the mobile communication terminal 105 is moved and the second zone disease information to be mapped to the map data, based on a control of the system 101, thereby enabling the user of the mobile communication terminal 105 to verify a location of the user and zone disease information corresponding to the location easily.

According to embodiments of the present invention, when a mobile communication terminal is moved, zone disease information corresponding to a location to which the mobile communication terminal is moved may be provided to the mobile communication terminal, whereby a user of the mobile communication terminal may handle a disease easily. Although a request for zone disease information is not received from the mobile communication terminal, corresponding zone disease information may be provided automatically when the mobile communication terminal is moved, whereby the user of the mobile communication terminal may obtain the zone disease information conveniently.

According to embodiments of the present invention, zone disease information corresponding to a location to which a mobile communication terminal is moved may be processed in a form of at least one of a bar graph, a line graph, and a diagram, and provided to the mobile communication terminal, whereby a user of the mobile communication terminal may be aware of the zone disease information easily.

Accordingly, by providing zone disease information, the user of the mobile communication terminal may be aware of a transmission state of an epidemic disease easily, and prepare preventive measures, whereby spread of the epidemic disease may be prevented to the maximum.

The method of providing region-based epidemic disease information according to embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

Accordingly, the invention is not limited to such embodiments, but rather to the broader scope of the presented claims and various obvious modifications and equivalent arrangements.

1. A system for providing region-based epidemic disease information, the system comprising:
a sensing unit to sense a movement of a mobile communication terminal from a first location to a second location; and
a processor to extract first zone disease information corresponding to the first location and second zone disease information corresponding to the second location from a database, in line with the sensing, to compare the extracted first zone disease information to the extracted second zone disease information, and to process the second zone disease information in a form of at least one of a bar graph, a line graph, and a diagram and provide the mobile communication terminal with the processed second zone disease information when the first zone disease information differs from the second zone disease information as a result of the comparing.

2. The system of claim 1, further comprising:
an analyzer to receive prescription information from a separate prescription information server, to analyze the received prescription information in view of a region code corresponding to a location of the prescription information server, and to store, in the database, zone disease information generated as a result of the analyzing.

3. The system of claim 2, wherein the analyzer analyzes the received prescription information, based on at least one of a disease type, a gender, an age, and a period.

4. The system of claim 1, wherein the processor verifies a region code corresponding to the first location and a region code corresponding to the second location from a code matching table, and extracts the first zone disease information and the second zone disease information corresponding to the verified region codes from the database.

5. (canceled)

6. The system of claim 1, wherein the processor provides the mobile communication terminal with a warning message along with the second zone disease information when a number of prescriptions with respect to a specific disease included in the second zone disease information is greater than or equal to a predetermined number.

7. The system of claim 1, wherein the sensing unit senses the movement of the mobile communication terminal when the first location and the second location are included in different zones.

8. A method of providing region-based epidemic disease information, the method comprising:
sensing a movement of a mobile communication terminal from a first location to a second location;
extracting first zone disease information corresponding to the first location and second zone disease information corresponding to the second location from a database, in line with the sensing; and
comparing the extracted first zone disease information to the extracted second zone disease information, and processing the second zone disease information in a form of at least one of a bar graph, a line graph, and a diagram and providing the mobile communication terminal with the processed second zone disease information when the first zone disease information differs from the second zone disease information as a result of the comparing.

9. The method of claim 8, further comprising:
receiving prescription information from a separate prescription information server, and analyzing the received prescription information in view of a region code corresponding to a location of the prescription information server; and
storing, in the database, zone disease information generated as a result of the analyzing.

10. The method of claim 9, wherein the analyzing comprises analyzing the received prescription information, based on at least one of a disease type, a gender, an age, and a period.

11. The method of claim 8, wherein the extracting comprises verifying a region code corresponding to the first location and a region code corresponding to the second location from a code matching table, and extracting the first zone disease information and the second zone disease information corresponding to the verified region codes from the database.

12. (canceled)

13. The method of claim 8, further comprising:
providing the mobile communication terminal with a warning message along with the second zone disease information when a number of prescriptions with respect to a specific disease included in the second zone disease information is greater than or equal to a predetermined number.

14. The method of claim 8, wherein the sensing comprises sensing the movement of the mobile communication terminal when the first location and the second location are included in different zones.
